(19) United States
(12) Patent Application Publication
(10) Pub. No.: US 2015/0356609 A1
(43) Pub. Date: Dec. 10, 2015

(54) INFORMATION DISTRIBUTION SYSTEM, INFORMATION DISTRIBUTION METHOD, AND RECORDING MEDIUM

(71) Applicant: NEC CORPORATION, Tokyo (JP)

(72) Inventor: Naoki SHIOTA, Tokyo (JP)

(73) Assignee: NEC CORPORATION, Tokyo (JP)

(21) Appl. No.: 14/655,786

(22) PCT Filed: Dec. 11, 2013
(86) PCT No.: PCT/JP2013/007274

§ 371 Date: Jun. 26, 2015

(30) Foreign Application Priority Data
Dec. 27, 2012 (JP) 2012-285239

(51) Int. Cl. G06Q 30/02

(52) U.S. Cl. CPC G06Q 30/0261; G06Q 30/0267

(57) ABSTRACT

An information distribution system includes a distribution server and a mobile terminal The distribution server includes: a distribution area information storage unit that stores advertisement information having a display area and a distribution region of the advertisement information that is larger than the display area of the advertisement information in association with each other; and a distribution advertisement determination unit that receives the present location information of the mobile terminal and distributes the advertisement information corresponding to the present location information to the mobile terminal. The mobile terminal includes: a present location positioning unit that performs positioning of the present location information and transmits the present location information; and an advertisement display determination unit that determines whether to display the distributed advertisement information based on the display area and the present location information that the present location positioning unit has performed positioning after receiving the advertisement information.

### TECHNICAL FIELD

The present invention relates to an information distribution system, an information distribution method, and an information distribution program.

### BACKGROUND ART

Recently, there has been known a technique in which an information distribution device simultaneously distributes advertisement information to mobile terminals of a large number of unspecified users via a network in order to increase sales of products handled by a variety of institutions. The mobile terminals are, for example, portable telephones and smartphones.

With a background of the prevalence of smartphones and the like, the number of users who use the Internet via portable telephones and portable terminals has been increasing. As such, the portable telephones, smartphones, and the like are expected to expand as advertisement media.

There are information distribution devices that record in advance advertisement information that indicates advertisements of products of institutions. The information distribution devices determine whether or not to distribute advertisement information according to the present locations of the portable terminals of users, for example.

Specifically, the information distribution device distributes advertisement information to portable terminals that are located within a certain range (for example, a 10-kilometer radius of an institution) from the institution that handles a product as an advertisement object. In other words, an area within a certain range from the institution is the distribution area, to which the information distribution device distributes advertisement information.

PTL 1 describes an information distribution device that distributes advertisement information of a product handled by an institution to mobile terminals located within a distribution area.

### CITATION LIST

### Patent Literature

PTL1: International Patent Publication WO2009/122498

### SUMMARY OF INVENTION

### Technical Problem

However, in some cases, the information distribution device described in PTL1 cannot immediately distribute information that is supposed to be distributed depending on the locations of users who are to receive the information. This is because, when wireless communications are used for distributing information, as the wireless communications have radio wave dead zones and locations or time periods that make the communications difficult due to congestion, the information distribution device cannot always use wireless communications whenever it needs to distribute information.

Further, if there are areas where information to be distributed is concentrated, users may find it difficult to use wireless communications in those areas. This is because, if users enter such areas, a large volume of distribution information is transmitted to user terminals at once, occupying the communication lines over a long period of time.

Further, if there are many users who use wireless communications in those areas, congestion may occur with high possibility, making it hard even for users irrelevant to the information distribution to use the wireless communications.

Thus, the present invention aims to provide an information distribution system, an information distribution method, and an information distribution program, which can surely display distribution information on user terminals without delay.

### Solution to Problem

An information distribution system according to one aspect to the present invention includes: a distribution server; and a mobile terminal that is connected with the distribution server via a communication network, wherein the distribution server includes: a distribution area information storage unit configured to store advertisement information that has a display area and a distribution region of the advertisement information that is larger than the display area of the advertisement information in association with each other; and a distribution advertisement determination unit configured to receive present location information of the mobile terminal from the mobile terminal and distribute the advertisement information corresponding to the present location information, which is acquired from the distribution area information storage unit, to the mobile terminal that has transmitted the present location information, and the mobile terminal includes: a present location positioning unit configured to perform positioning of the present location information of the mobile terminal and transmit the present location information to the distribution server; and an advertisement display determination unit configured to determine whether to display the advertisement information distributed from the distribution server based on a display area included in the advertisement information and the present location information that the present location positioning unit has performed positioning after receiving the advertisement information.

An information distribution method according to one aspect to the present invention, that is executed by a distribution server that is connected via a communication network with a mobile terminal that performs positioning of present location information and determines whether to display distributed advertisement information based on a display area in advertisement information and the present location information that has been performed positioning after receiving the advertisement information, the information distribution method includes: storing the advertisement information that has the display area and a distribution region of the advertisement information that is larger than the display area of the advertisement information in association with each other; receiving the present location information of the mobile terminal from the mobile terminal; and distributing the advertisement information corresponding to the present location information to the mobile terminal that has transmitted the present location information.

An information distribution program according to one aspect to the present invention, that is installed in a distribution server that is connected via a communication network with a mobile terminal that performs positioning of present location information and determines whether to display distributed advertisement information based on a display area in the advertisement information and the present location information that has been performed positioning after receiving the advertisement information, the information distribution program causes the distribution server to execute: storing processing that stores the advertisement information that has the display area and a distribution region of the advertisement information that is larger than the display area of the advertisement information in association with each other; receiving processing that receives the present location information of the mobile terminal from the mobile terminal; and distributing processing that distributes the advertisement information corresponding to the present location information that has been stored by the storing processing to the mobile terminal that has transmitted the present location information that has been received by the receiving processing.

### Advantageous Effects of Invention

According to the present invention, distribution information can be surely displayed on user terminals without delay.

### BRIEF DESCRIPTION OF DRAWINGS

FIG. 1 is a system configuration diagram illustrating a configuration example of an exemplary embodiment of an information distribution system according to the present invention;

FIG. 2 is a block diagram illustrating a configuration example of an advertisement distribution server 101;

FIG. 3 is an explanatory diagram illustrating an example of information of advertisements stored in an advertisement information storage unit 111;

FIG. 4 is an explanatory diagram illustrating a correspondence relationship between display ranges stored in the advertisement information storage unit 111 and the ranges on an actual map;

FIG. 5 is an explanatory diagram illustrating an example of information of distribution areas stored in a distribution area information storage unit 112;

FIG. 6 is an explanatory diagram illustrating a correspondence relationship between area IDs stored in the distribution area information storage unit 112 and grids on a map;

FIG. 7 is an explanatory diagram illustrating a correspondence relationship between a display area and a distribution area of an advertisement stored in the distribution area information storage unit 112;

FIG. 8 is an explanatory diagram illustrating an example of information of a distribution history stored in a distribution history information storage unit 116;

FIG. 9 is an explanatory diagram illustrating an example of information of a distribution history stored in the distribution history information storage unit 116;

FIG. 10 is an explanatory diagram illustrating an example of information of a display history stored in a display history information

FIG. 11 is a block diagram illustrating a configuration example of a user terminal 201;

FIG. 12 is an explanatory diagram illustrating an example of information of advertisements stored in a received advertisement storage unit 212;

FIG. 13 is an explanatory diagram illustrating an example of information of advertisements stored in the received advertisement storage unit 212;

FIG. 14 is a flowchart illustrating operation of advertisement distribution processing that is executed between the advertisement distribution server 101 and a user terminal 201 at normal time;

FIG. 15 is a flowchart illustrating operation of advertisement display processing that is executed in a user terminal 201 at normal time;

FIG. 16 is an explanatory diagram illustrating an example of distribution areas on a map and the entrance record of a user;

FIG. 17 is a flowchart illustrating operation of advertisement display history transmission processing of a user terminal 201;

FIG. 18 is a flowchart illustrating operation of distribution area information update processing of a distribution area update unit 119;

FIG. 19 is an explanatory diagram illustrating an example of distribution area information update processing of the distribution area update unit 119; and

FIG. 20 is a block diagram illustrating an overview of an information distribution system according to the present invention.

### DESCRIPTION OF EMBODIMENTS

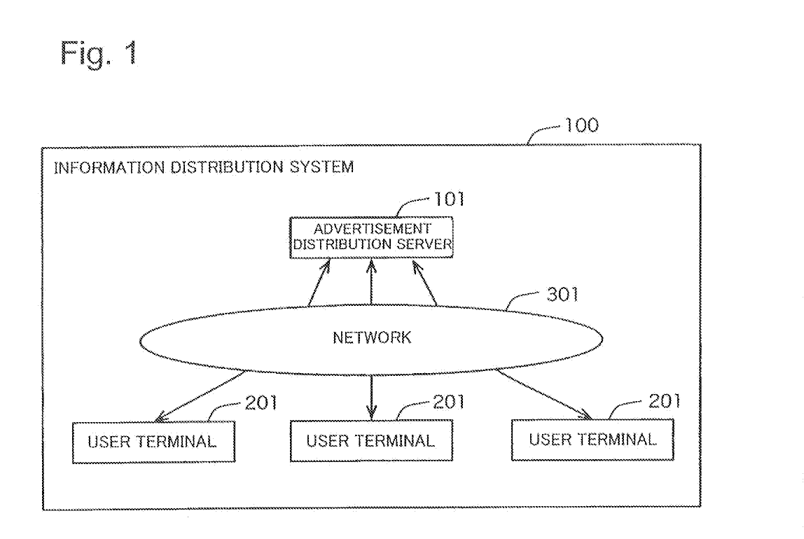

The following will describe the exemplary embodiment of the present invention with reference to the drawings. FIG. 1 is a system configuration diagram illustrating a configuration example of an exemplary embodiment of the information distribution system according to the present invention. An information distribution system 100 illustrated in FIG. 1 includes an advertisement distribution server 101 and user terminals 201.

FIG. 1 illustrates an example where the advertisement distribution server 101 is connected with a plurality of user terminals 201 via a network 301.

The advertisement distribution server 101 distributes advertisement data to the user terminals 201. The advertisement distribution server 101 distributes appropriate advertisement information according to the positions of the user terminals 201.

The user terminals 201 have a communication function and a function of presenting advertisements to a user who uses the terminal. The user terminals 201 are, for example, portable telephones, smartphones, onboard terminals, and the like.

As for a method of presenting advertisements to a user herein, texts and images of advertisements are displayed on a screen as an example method. Other methods of presenting advertisements to a user include a method using audio or alarm rumbling and a method of displaying motion pictures.

In the present invention, the method of presenting advertisements to a user is not limited to a specific presenting method. An arbitrary presentation method may be adapted as a method of presenting advertisements to a user.

The network 301 communicably connects the advertisement distribution server 101 and the user terminals 201. The network 301 herein is a communication network of portable telephones. The communication network of portable telephones includes, for example, W-CDMA (Wideband Code Division Multiple Access) and the like.

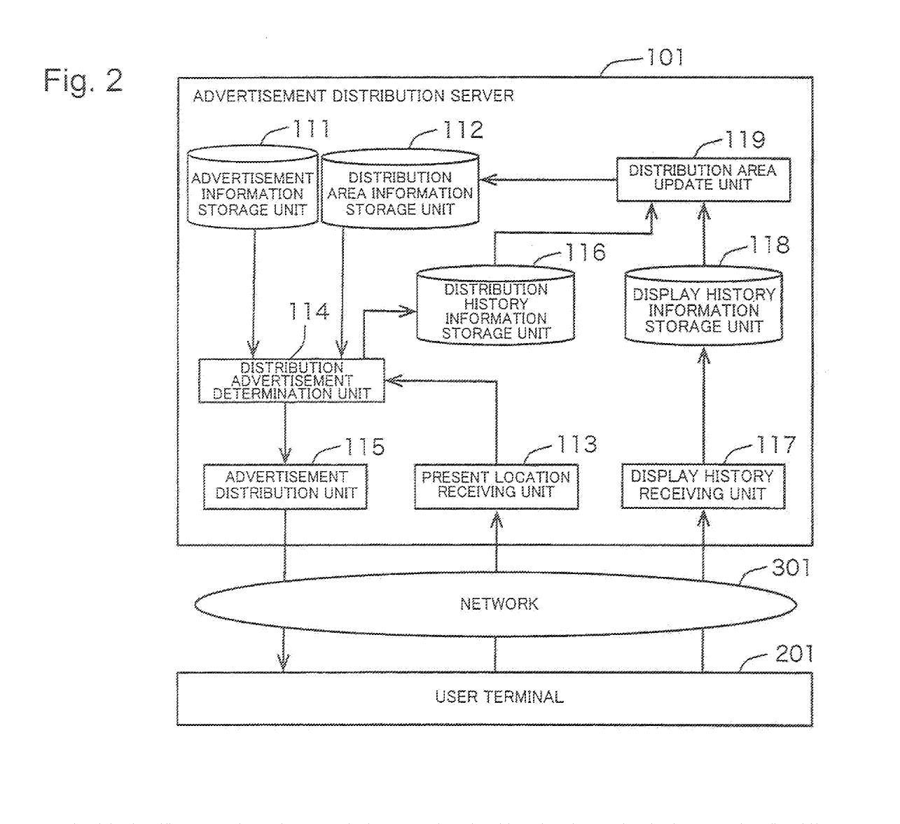

Next, the following will describe the configuration of the advertisement distribution server 101 with reference to FIG. 2. FIG. 2 is a block diagram illustrating a configuration example of the advertisement distribution server 101.

The advertisement distribution server 101 illustrated in FIG. 2 includes an advertisement information storage unit 111, a distribution area information storage unit 112, a present location receiving unit 113, a distribution advertisement determination unit 114, an advertisement distribution unit 115, a distribution history information storage unit 116, a display history receiving unit 117, a display history information storage unit 118, and a distribution area update unit 119.

The advertisement information storage unit 111 has a function of storing information of advertisements to be distributed.

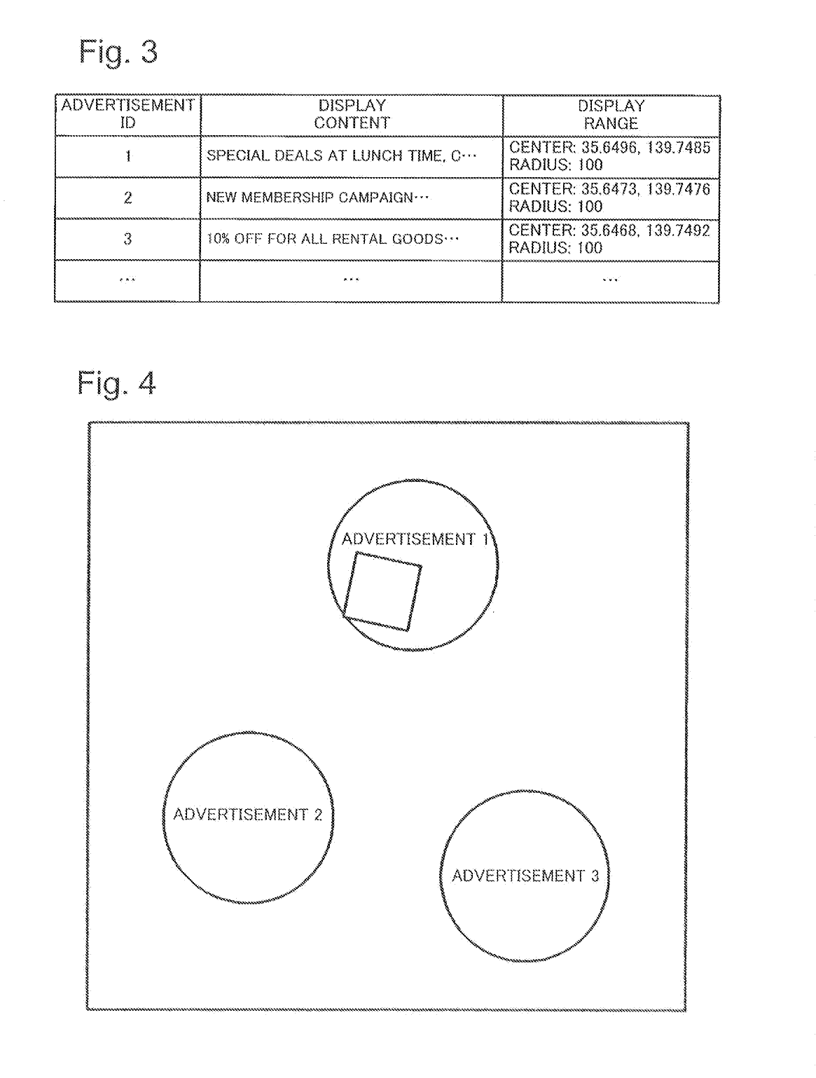

FIG. 3 illustrates an example of information of advertisements stored in the advertisement information storage unit 111. The information of an advertisement stored in the advertisement information storage unit 111 is configured by an advertisement ID that uniquely identifies the advertisement, a display content to be displayed on user terminals 201, and a display range that is information of an area within which the advertisement is displayed.

The area for displaying advertisement is assumed herein as a circle area. The advertisement information storage unit 111 stores the longitude and latitude of the center and the radius of the circle as a display range. The units of the radius of the circle are meters.

FIG. 4 illustrates the display ranges of advertisement information illustrated in FIG. 3. FIG. 4 is an explanatory diagram illustrating a correspondence relationship between display ranges stored in the advertisement information storage unit 111 and the ranges on an actual map.

Each circle on the map illustrated in FIG. 4 corresponds to each advertisement information illustrated in FIG. 3. For example, the range that indicates the display range of the advertisement information of advertisement ID 1 as illustrated in FIG. 3 on the map is the inside of the circle that is denoted by “Advertisement 1” illustrated in FIG. 4. It should be noted that the rectangle illustrated in FIG. 4 represents a building.

The distribution area information storage unit 112 has a function of storing information of areas, to which advertisements are distributed.

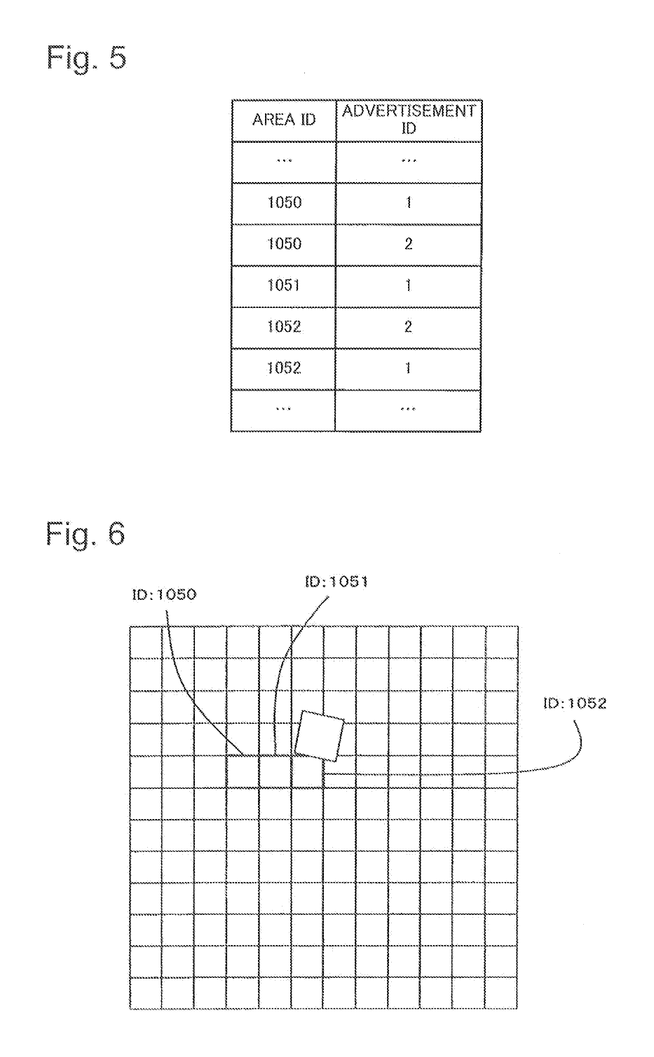

FIG. 5 illustrates an example of information of distribution areas stored in the distribution area information storage unit 112. The information of a distribution area stored in the distribution area information storage unit 112 is configured by an area ID and an advertisement ID.

The area ID is an ID that defines a rectangle enclosed by border lines, which is formed by dividing the map by certain intervals with border lines in an east to west direction and a south to north direction (hereinafter, the inside of the rectangle is referred to as a grid). FIG. 6 illustrates a correspondence relationship between each of area IDs illustrated in FIG. 5 and a grid.

FIG. 6 is an explanatory diagram illustrating a correspondence relationship between the area IDs stored in the distribution area information storage unit 112 and grids on the map. Each grid on the map illustrated in FIG. 6 corresponds to each area ID illustrated in FIG. 5. For example, the grid of area ID 1050 on the map as illustrated in FIG. 5 is in the fourth column from the left and the fifth row from the top as illustrated in FIG. 6.

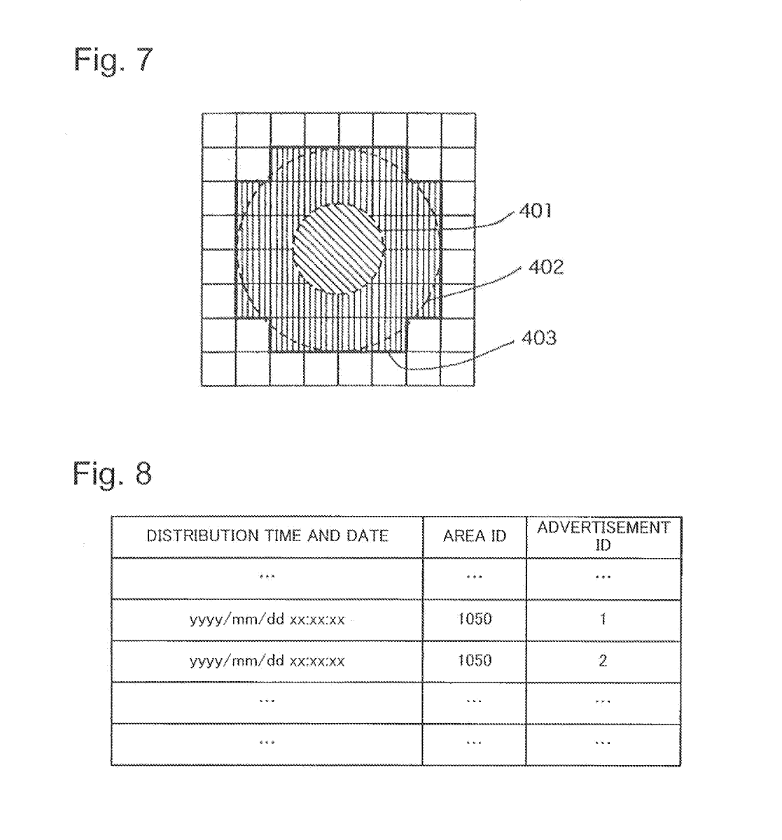

The following will describe the method of automatically determining a distribution area based on the display area information of an advertisement stored in the advertisement information storage unit 111. FIG. 7 is an explanatory diagram illustrating a correspondence relationship between a display area and a distribution area of an advertisement stored in the distribution area information storage unit 112.

The inside of a circle 401 as illustrated in FIG. 7 is a display area of an advertisement, of which advertisement ID is X. Further, each grid illustrated in FIG. 7 corresponds to each area with an assigned area ID.

A circle 402 that has a larger radius than the circle 401 by 200 meters is calculated. Then, the minimum set of the areas that enclose the circle 402, indicated by vertical lines, is a distribution area 403.

A row, of which advertisement ID is X and area ID belongs to the distribution area 403, is added to the distribution area information storage unit 112 so that the advertisement, of which advertisement ID is X, is distributed to all areas that belong to the distribution area 403.

Once this processing is executed to all the advertisements, the initial value is set in the distribution area information storage unit 112. As preparation for operation of the system, the initial value is needed to be set in the distribution area information storage unit 112.

Setting the initial value in the distribution area information storage unit 112 may be, for example, automatically performed by a program, such as, an advertisement registration interface, when an advertisement agent has registers an advertisement in the advertisement information storage unit 111.

The present location receiving unit 113 has a function of receiving present location (position) information of a user terminal 201 that is transmitted from the user terminal 201 and a user terminal ID that is the ID of the user terminal 201. Upon receiving the present location information from a user terminal 201, the present location receiving unit 113 outputs, to the distribution advertisement determination unit 114, the received present location information and the ID of the user terminal 201 that has transmitted the present location information.

The distribution advertisement determination unit 114 has a function of determining advertisement information to be distributed according to the present location of the user terminal 201.

Based on the present location information input from the present location receiving unit 113, the distribution advertisement determination unit 114 determines which area ID is the area where the user is. The distribution advertisement determination unit 114 refers to the distribution area information storage unit 112 to receive a list of advertisement IDs that are associated with the determined area ID. After receiving the advertisement IDs, the distribution advertisement determination unit 114 refers to the advertisement information storage unit 111 to receive advertisement information that is associated with the acquired advertisement IDs.

After receiving the advertisement information, the distribution advertisement determination unit 114 outputs the list of the acquired advertisement information and the user terminal ID input from the present location receiving unit 113 to the advertisement distribution unit 115.

The advertisement distribution unit 115 has a function of distributing a list of distribution advertisements to the user terminal 201. When the list of advertisement information, the area ID, and the user terminal ID are input from the distribution advertisement determination unit 114, the advertisement distribution unit 115 transmits the list of advertisement information and the area ID to the user terminal 201 corresponding to the user terminal ID.

The reason for transmitting the area ID is because the area ID of the area where the user terminal 201 has received the advertisement information will be used in distribution area information update processing performed by the distribution area update unit 119 as will be described later herein.

When the advertisement distribution unit 115 distributes the advertisement information to the corresponding user terminal 201, the distribution advertisement determination unit 114 stores the advertisement ID of the distributed advertisement and the area ID in the distribution history information storage unit 116 together with the distribution time and date.

The distribution history information storage unit 116 has a function of storing the distribution histories of advertisements.

FIG. 8 illustrates an example of distribution history information that is stored in the distribution history information storage unit 116. FIG. 8 is an explanatory diagram illustrating an example of distribution history information stored in the distribution history information storage unit 116.

The distribution history information stored in the distribution history information storage unit 116 is configured by distribution time and date that is time and date when the distribution is performed, an area ID of the area where the user terminal 201 exists at the time of the distribution, and an advertisement ID of the distributed advertisement.

The display history receiving unit 117 has a function of receiving a history of displaying distributed advertisement information on the user terminal 201. The display history of advertisement information is transmitted from a display history transmission unit 218 of the user terminal 201. The display history receiving unit 117 outputs the received display history to the display history information storage unit 118.

The display history information storage unit 118 has a function of storing the display histories of advertisements.

FIG. 10 illustrates an example of display history information that is stored in the display history information storage unit 118. FIG. 10 is an explanatory diagram illustrating an example of display history information stored in the display history information storage unit 118. The display history information stored in the display history information storage unit 118 is configured by an advertisement ID of the advertisement displayed on the user terminal 201, an area ID of the distributed area, and display time and date when the advertisement information has been displayed.

The distribution area update unit 119 has a function of updating distribution area information based on the distribution history and display history of the advertisement.

The distribution area update unit 119 refers to the distribution history information storage unit 116 and the display history information storage unit 118 to calculate advertisement display records for each area. After the calculation, the distribution area update unit 119 deletes advertisements with low display records from the distribution area information storage unit 112.

The distribution area update unit 119 periodically executes processing of updating information of distribution areas, such as once a week. A specific processing content for updating the distribution area information by the distribution area update unit 119 will be described later herein.

In the exemplary embodiment, the distribution advertisement determination unit 114 and the distribution area update unit 119 are implemented, for example, by a CPU (Central Processing Unit) that runs in accordance with a program.

Further, the present location receiving unit 113, the advertisement distribution unit 115, and the display history receiving unit 117 are implemented by a CPU that runs in accordance with a program and a communication control device, such as a network card.

Further, the advertisement information storage unit 111, the distribution area information storage unit 112, the distribution history information storage unit 116, and the display history information storage unit 118 are implemented, for example, by a storage device, such as a database system, and a control unit that controls accesses to the storage device.

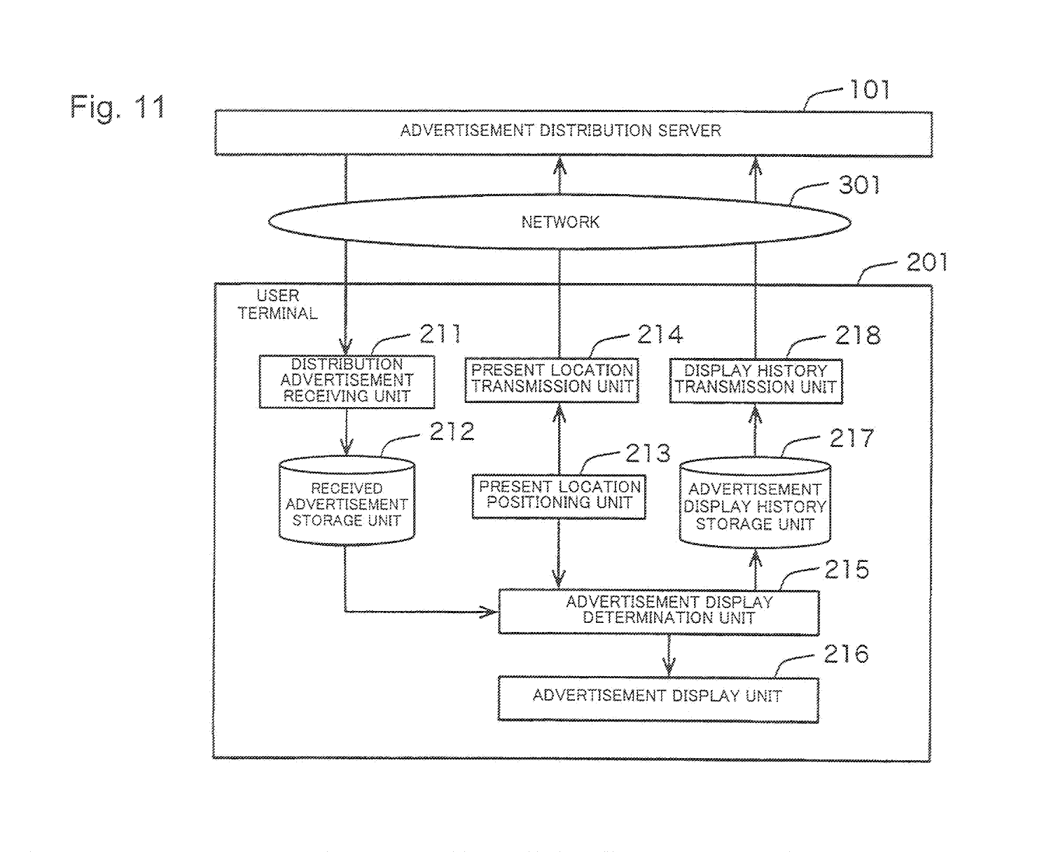

The following will describe the configuration inside the user terminal 201 with reference to FIG. 11. FIG. 11 is a block diagram illustrating a configuration example of the user terminal 201.

The user terminal 201 illustrated in FIG. 11 includes a distribution advertisement receiving unit 211, a received advertisement storage unit 212, a present location positioning unit 213, a present location transmission unit 214, an advertisement display determination unit 215, an advertisement display unit 216, an advertisement display history storage unit 217, and a display history transmission unit 218.

The distribution advertisement receiving unit 211 has a function of receiving the advertisement information and area ID transmitted from the advertisement distribution server 101. The distribution advertisement receiving unit 211 outputs the received advertisement information list and area ID in association with each other to the received advertisement storage unit 212.

The received advertisement storage unit 212 has a function of storing the advertisement information and area ID that are received by the distribution advertisement receiving unit 211 in association with each other.

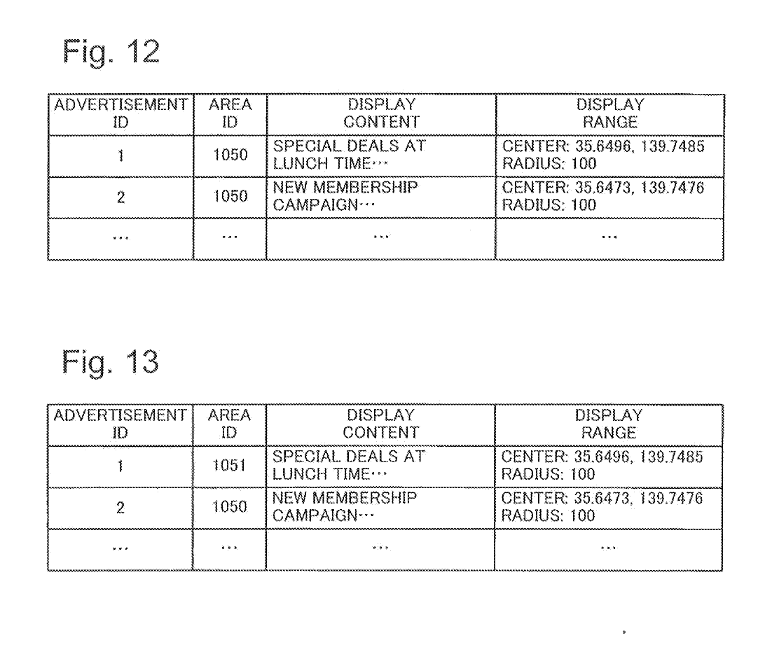

FIG. 12 illustrates an example of advertisement information stored in the received advertisement storage unit 212. FIG. 12 is an explanatory diagram illustrating an example of advertisement information stored in the received advertisement storage unit 212. The advertisement information stored in the received advertisement storage unit 212 is configured by advertisement information on the side of the advertisement distribution server 101 and an area ID where the user terminal 201 has received the advertisement information. It should be noted that FIG. 13 is an explanatory diagram illustrating another example of advertisement information stored in the received advertisement storage unit 212.

Since the user terminal 201 retains a smaller amount of data than the advertisement distribution server 101 side does, the advertisement information stored in the received advertisement storage unit 212 is deleted in order from the oldest storing time. Further, when advertisement information of the same advertisement ID is input, the received advertisement storage unit 212 overwrites the area ID of the existing advertisement information with the area ID of new advertisement information.

The present location positioning unit 213 has a function of performing positioning of the present location of the user terminal 201 at certain time intervals. In this exemplary embodiment, the present location positioning unit 213 performs positioning of the present location using GPS (Global Positioning System).

The result of performing positioning by the present location positioning unit 213 is transmitted to the advertisement distribution server 101 via the present location transmission unit 214. Further, the result of performing positioning by the present location positioning unit 213 is output to the advertisement display determination unit 215 where the result is used for determining display of the advertisement.

The present location transmission unit 214 has a function of transmitting present location information of the user terminal 201 that has been performed positioning by the present location positioning unit 213 and the user terminal ID to the advertisement distribution server 101. The present location transmission unit 214 executes processing of transmitting the present location information to the advertisement distribution server 101 at certain time intervals, such as, every 10 seconds. As the result, the latest present location information of the user terminal 201 is notified to the advertisement distribution server 101.

The advertisement display determination unit 215 has a function of determining an advertisement to be displayed on the user terminal 201 using the information stored in the received advertisement storage unit 212 and the present location information performed positioning by the present location positioning unit 213.

The advertisement display determination unit 215 refers to the information of the display range of the advertisement in the received advertisement storage unit 212. Further, the advertisement display determination unit 215 refers to the present location information in the present location positioning unit 213. If the present location is within the display range based on the referred respective information, the advertisement display determination unit 215 stores the display content of corresponding advertisement in the advertisement display history storage unit 217.

Further, as with storing in the advertisement display history storage unit 217, the advertisement display determination unit 215 notifies the advertisement display unit 216 of the content of the advertisement to be displayed.

The advertisement display unit 216 has a function of displaying the display contents of advertisements. The advertisement display unit 216 displays the display content notified by the advertisement display determination unit 215 on the screen of the user terminal 201 to present the advertisement to the user.

The advertisement display history storage unit 217 has a function of storing advertisement display histories. Advertisement display histories as illustrated in FIG. 10 are stored in the advertisement display history storage unit 217 in the same way as in the display history information storage unit 118 of the advertisement distribution server 101.

The display history transmission unit 218 has a function of transmitting advertisement display histories to the advertisement distribution server 101.

The display history transmission unit 218 acquires the stored advertisement display history from the advertisement display history storage unit 217. After the acquisition, the display history transmission unit 218 transmits the acquired advertisement display history to the advertisement distribution server 101. If the transmission is successful, the display history transmission unit 218 deletes the transmitted advertisement display history from the advertisement display history storage unit 217.

The display history transmission unit 218 executes the transmission processing and deletion processing of advertisement display histories, for example, automatically once a day during a time period during which the user is not using the terminal.

It should be noted that, in the exemplary embodiment, the present location positioning unit 213, the advertisement display determination unit 215, and the advertisement display unit 216, are implemented, for example, by a CPU that runs in accordance with a program.

Further, the distribution advertisement receiving unit 211, the present location transmission unit 214, and the display history transmission unit 218 are implemented by a CPU that runs in accordance with a program and a wireless interface.

Further, the received advertisement storage unit 212 and the advertisement display history storage unit 217 are implemented, for example, by a recording medium, such as a flash memory, and a control unit that controls accesses to the recording medium.

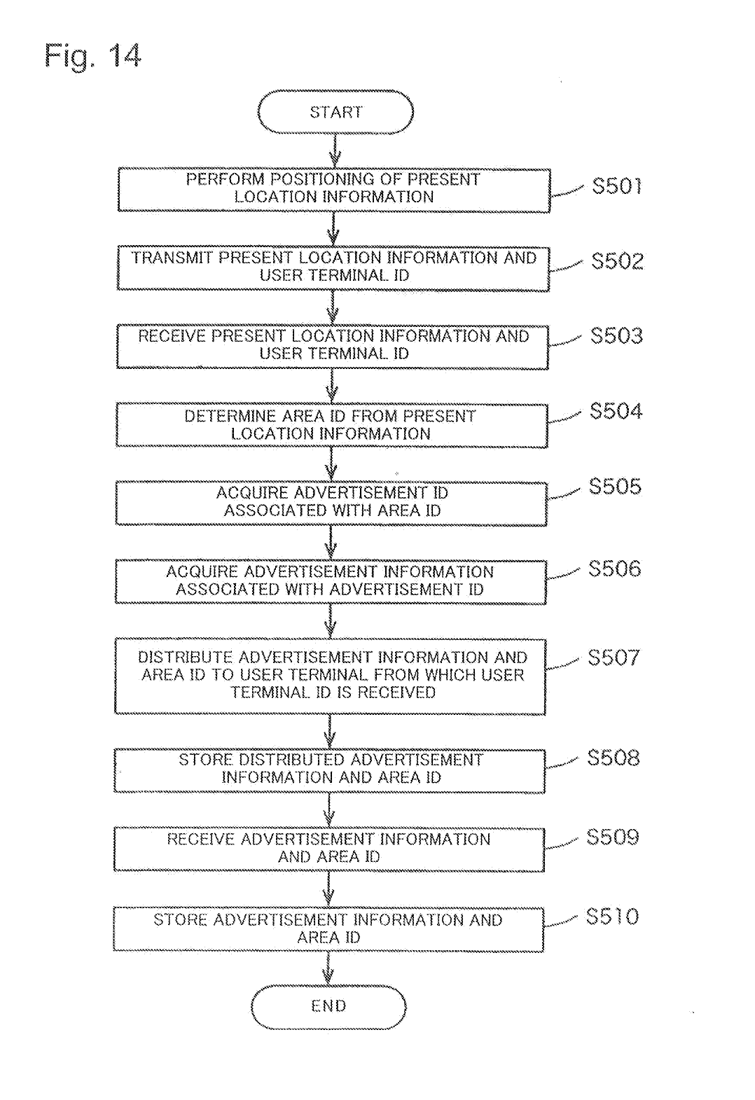

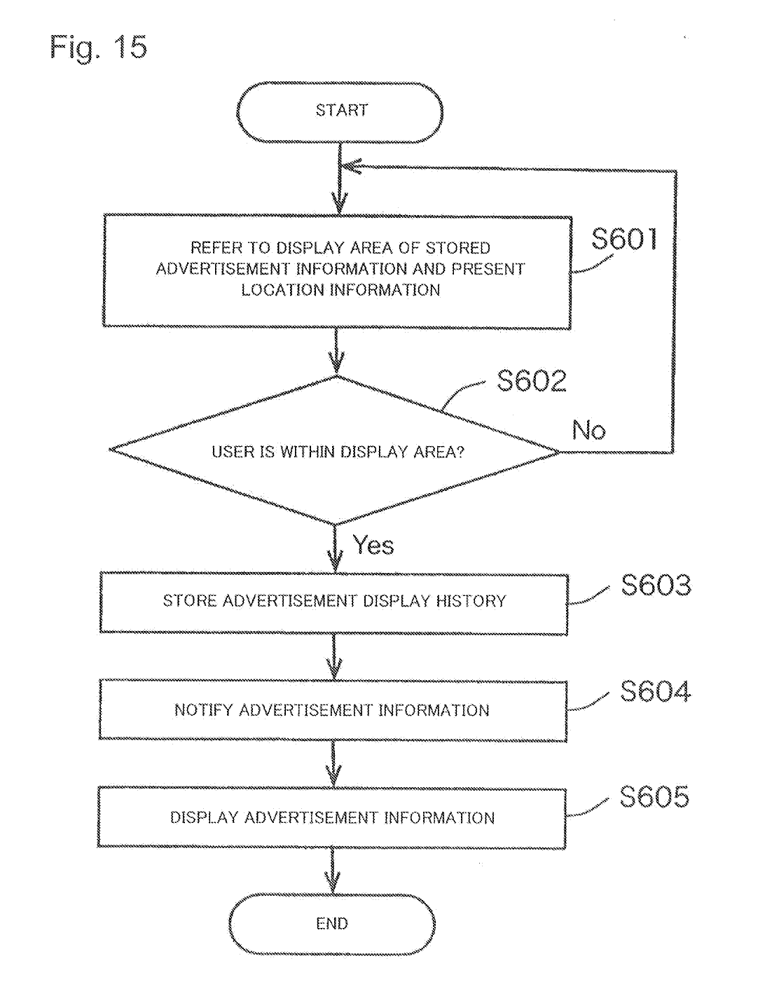

The following will describe the operation of advertisement distribution processing and advertisement display processing of the present invention with reference to FIGS. 14 and 15. FIG. 14 is a flowchart illustrating operation of advertisement distribution processing that is executed between the advertisement distribution server 101 and a user terminal 201 at normal time. FIG. 15 is a flowchart illustrating operation of advertisement display processing that is executed in a user terminal 201 at normal time.

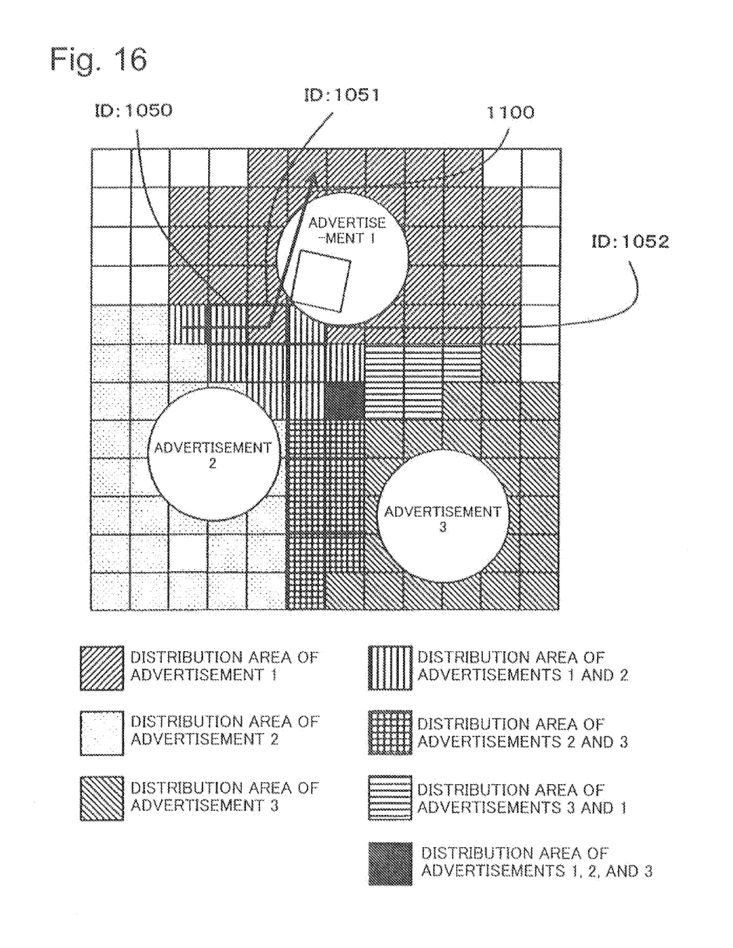

FIG. 16 is an explanatory diagram illustrating an example of distribution areas on a map and the entrance record of a user. As illustrated in FIG. 16, the left diagonally shaded portion indicates the distribution area of an advertisement of advertisement ID 1; the halftone dot portion, advertisement ID 2; the right diagonally shaded portion, advertisement ID 3, respectively. Further, the vertically shaded portion indicates the distribution area of advertisements of advertisement IDs 1 and 2; the lattice portion, advertisement IDs 2 and 3; the horizontally shaded portion, advertisement IDs 3 and 1, respectively. The black portion indicates the distribution area of advertisements of advertisement IDs 1, 2, and 3.

Further, as illustrated by an entrance record 1100 in FIG. 16, suppose a user passes through the areas respectively corresponding to area IDs 1050 and 1051 in order, before entering the display area of advertisement 1. The operation of the advertisement distribution server 101 and the user terminal 201 in this case will be described with reference to FIGS. 14 and 15.

First, the operation of the advertisement distribution server 101 and the user terminal 201 when the advertisement distribution processing is executed will be described with reference to FIG. 14.

Suppose a user who carries a user terminal 201, of which ID is 10, enters an area corresponding to the area ID 1050. Here, the present location positioning unit 213 performs positioning of the present location of the user terminal 201 corresponding to the area ID 1050 (step S501). The present location positioning unit 213 outputs the positioning result to the present location transmission unit 214.

The present location transmission unit 214 transmits the present location information of the user terminal 201 corresponding to the area ID 1050 and the user terminal ID 10 to the advertisement distribution server 101 via the network 301 (step S502).

The present location receiving unit 113 receives the transmitted present location information of the user terminal 201 corresponding to the area ID 1050 and the user terminal ID 10 (step S503). After the reception, the present location receiving unit 113 outputs the received information to the distribution advertisement determination unit 114.

Based on the present location information input from the present location receiving unit 113, the distribution advertisement determination unit 114 determines which area ID is the area where the user corresponding to the user terminal ID 10 is (step S504). In this case, the distribution advertisement determination unit 114 determines that the user is in the area of area ID 1050.

After the determination, the distribution advertisement determination unit 114 refers to the distribution area information storage unit 112 to acquire a list of advertisement IDs that are associated with the area ID 1050 (step S505). Referring to FIG. 5, the advertisement IDs associated with the area ID 1050 are two advertisement IDs 1 and 2. Thus, two advertisement IDs of advertisement IDs 1 and 2 are acquired.

After acquiring the advertisement IDs, the distribution advertisement determination unit 114 refers to the advertisement information storage unit 111 to acquire advertisement information that is associated with the acquired advertisement IDs 1 and 2 (step S506). After acquiring the advertisement information, the distribution advertisement determination unit 114 outputs the list of the acquired advertisement information and the user terminal ID 10 to the advertisement distribution unit 115.

When the list of advertisement information corresponding to the advertisement IDs 1 and 2, the area ID 1050, and the user terminal ID 10 are input from the distribution advertisement determination unit 114, the advertisement distribution unit 115 distributes the list of advertisement information and the area ID 1050 to the user terminal 201 corresponding to the user terminal ID 10 (step S507).

When the advertisement distribution unit 115 distributes the advertisement information, the distribution advertisement determination unit 114 stores the advertisement IDs 1 and 2 that are the advertisement IDs of the distributed advertisement information and the area ID 1050 in the distribution history information storage unit 116 together with the distribution time and date (step S508).

Here, as illustrated in FIG. 8, the information stored in the distribution history information storage unit 116 is a content in which the distribution time and date, the advertisement ID 1, and the area ID 1050 are associated with each other and a content in which the distribution time and date, the advertisement ID 2, and the area ID 1050 are associated with each other.

The distribution advertisement receiving unit 211 in the user terminal 201, of which user terminal ID is 10, receives the list of advertisement information and the area ID 1050 that are distributed from the advertisement distribution server 101 (step S509). After the reception, the distribution advertisement receiving unit 211 outputs the received list of advertisement information and area ID 1050 in association with each other to the received advertisement storage unit 212.

The received advertisement storage unit 212 stores the list of advertisement information and the area ID that have been input from the distribution advertisement receiving unit 211 (step S510). Here, the information stored in the received advertisement storage unit 212 is a content in which the advertisement information of advertisement IDs 1 and 2 is associated with the area ID 1050 as illustrated in FIG. 12.

The following will describe the operation of the user terminal 201 when the advertisement display processing is executed in the above conditions with reference to FIG. 15.

When the advertisement information is stored in the received advertisement storage unit 212, the advertisement display determination unit 215 refers to the display range of the advertisement in the received advertisement storage unit 212 and the present location information in the present location positioning unit 213 (step S601). Based on the referred two pieces of information, the advertisement display determination unit 215 determines whether or not the user is within the display area of the advertisement (step S602).

Since the user is still in the area corresponding to the area ID 1050, thus, not within the display areas of advertisement IDs 1 and 2 (No at step S602), the advertisement display determination unit 215 does not notify the advertisement display unit 216.

Next, the user moves into the area corresponding to the area ID 1051. In the same way as with the area ID 1050, at this time, the present location transmission unit 214 transmits the present location information of the user terminal 201 corresponding to the area ID 1051 and the user terminal ID 10 to the advertisement distribution server 101 via the network 301 (step S502).

The present location receiving unit 113 receives the present location information of the user terminal 201 corresponding to the transmitted area ID 1051 and the user terminal ID 10 (step S503). The distribution advertisement determination unit 114 determines that the user is in the area of area ID 1051 based on the present location information input from the present location receiving unit 113 (step S504).

Next, the distribution advertisement determination unit 114 refers to the distribution area information storage unit 112 to acquire a list of advertisement IDs that are associated with the area ID 1051 (step S505). Referring to FIG. 5, the advertisement ID associated with the area ID 1051 is only the advertisement ID 1, thus, the advertisement ID of advertisement ID 1 is acquired.

After acquiring the advertisement ID, the distribution advertisement determination unit 114 refers to the advertisement information storage unit 111 to acquire advertisement information that is associated with the acquired advertisement ID 1 (step S506).

After acquiring the advertisement information, the distribution advertisement determination unit 114 outputs the list of the acquired advertisement information and the user terminal ID 10 to the advertisement distribution unit 115. The advertisement distribution unit 115 distributes the list of advertisement information and the area ID 1051 to the user terminal 201 corresponding to the user terminal ID 10 (step S507).

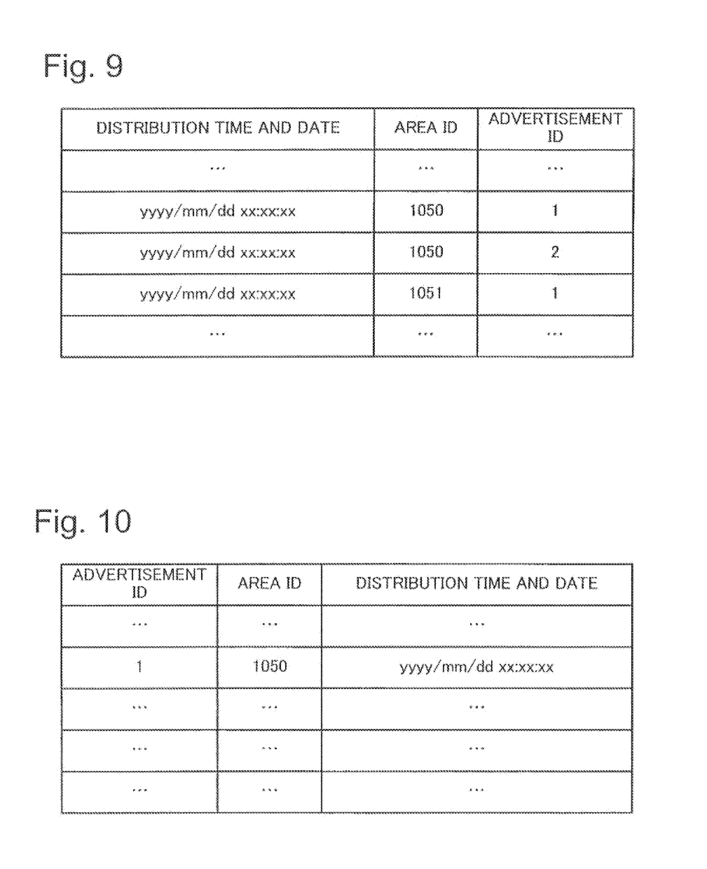

When distributed by the advertisement distribution unit 115, the distribution advertisement determination unit 114 stores the advertisement ID 1 that is the advertisement ID of the distributed advertisement information and the area ID 1051 in the distribution history information storage unit 116 together with the distribution time and date (step S508). Here, as illustrated in FIG. 9, a content in which the distribution time and date, the advertisement ID 1, and the area ID 1051 are associated with each other is newly added to the information stored in the distribution history information storage unit 116.

The distribution advertisement receiving unit 211 in the user terminal 201, of which user terminal ID is 10, receives the list of advertisement information and the area ID 1051 that are distributed from the advertisement distribution server 101 (step S509). After the reception, the distribution advertisement receiving unit 211 outputs the received list of advertisement information and area ID 1051 in association with each other to the received advertisement storage unit 212.

The received advertisement storage unit 212 stores the list of advertisement information and the area ID that have been input from the distribution advertisement receiving unit 211 (step S510). When the advertisement information of the same advertisement ID is input, the received advertisement storage unit 212 overwrites the area ID 1050 of the existing advertisement information of advertisement ID 1 with the area ID 1051 of new advertisement information of advertisement ID 1.

Thus, the information stored in the received advertisement storage unit 212 becomes a content in which the advertisement information of advertisement ID 1 is associated with the area ID 1051 and a content in which the advertisement information of advertisement ID 2 is associated with the area ID 1050, as illustrated in FIG. 13.

By repeatedly executing the advertisement distribution processing as described above, the present location information of the user is conveyed to the advertisement distribution server 101 and appropriate advertisement information is distributed to the user terminal 201.

In the same way as with the area ID 1050, the advertisement display determination unit 215 refers to the display ranges of the advertisements and the present location information (step S601) and determines whether or not the user is in the display areas of the advertisements (step S602). Since the user is still in the area corresponding to the area ID 1051, thus, not within the display areas of advertisement IDs 1 and 2 (No at step S602), the advertisement display determination unit 215 does not notify the advertisement display unit 216.

Thereafter, the user enters the display area of the advertisement ID 1. Here, the advertisement display determination unit 215 determines whether or not the user is within the area corresponding to the display area of the advertisement ID 1 based on the present location information that is referred to in the present location positioning unit 213 (step S602).

If it is determined that the user is within the area (Yes at step S602), the advertisement display determination unit 215 stores the display content of the advertisement of advertisement ID 1 acquired from the received advertisement storage unit 212 in the advertisement display history storage unit 217 (step S603). The information stored in the advertisement display history storage unit 217 is a content in which the advertisement ID 1, the area ID 1050, and the display time and date are associated with each other, as illustrated in FIG. 10.

At the same time as storing the acquired display content of the advertisement in the advertisement display history storage unit 217, the advertisement display determination unit 215 notifies the advertisement display unit 216 of the display content of the advertisement of advertisement ID 1 (step S604).

The advertisement display unit 216 displays the display content of the advertisement of advertisement ID 1 notified by the advertisement display determination unit 215 on the screen of the user terminal 201 to present the advertisement to the user (step S605). The advertisement display unit 216 presents the notified advertisement to the user with an adequate method, such as, displaying the notified advertisement on the screen of the terminal or reading it out as a sound.

Thereafter, the user passes through the display area of advertisement ID 1, but, does not enter the display area of advertisement ID 2. Thus, the information that is stored in the received advertisement storage unit 212, in which the advertisement information of advertisement ID 2 and the area ID 1050 are associated with each other, is not displayed on the user terminal 201. After a certain time period has passed, the information, in which the advertisement information of advertisement ID 2 and the area ID 1050 are associated with each other, is deleted from the received advertisement storage unit 212.

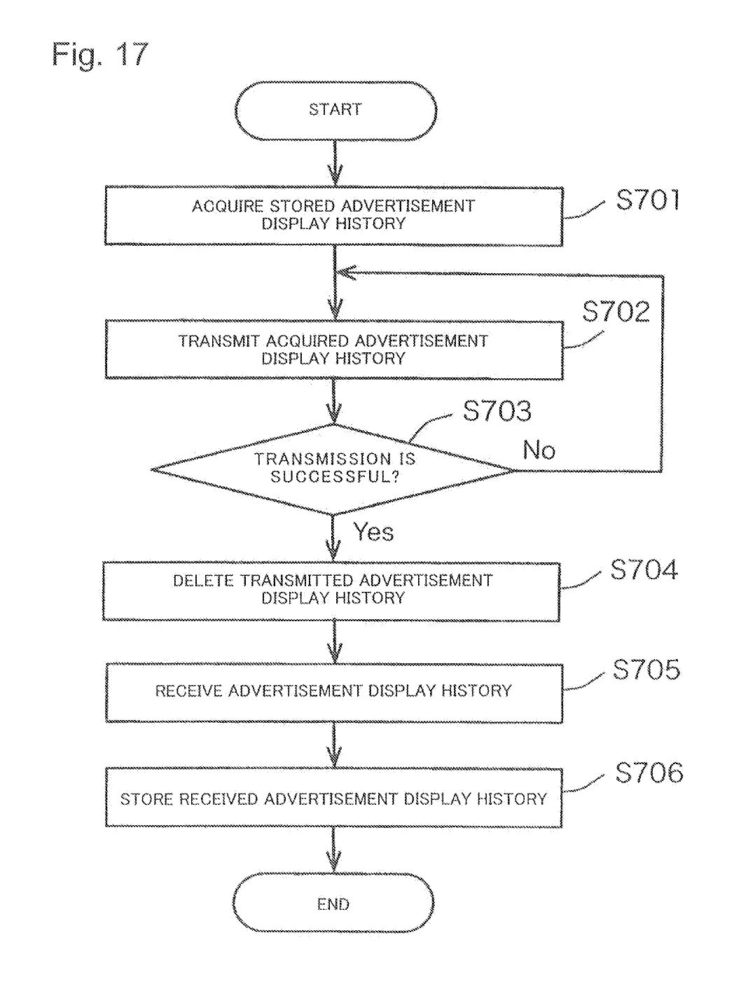

Next, the following will describe the operation of the user terminal 201 when transmitting the advertisement display history to the advertisement distribution server 101 after the user acquiring the entrance record illustrated in FIG. 16 with reference to FIG. 17. FIG. 17 is a flowchart illustrating operation of transmission processing of an advertisement display history of the user terminal 201.

In the exemplary embodiment, the display history transmission unit 218 in the user terminal 201 executes transmission processing and deletion processing of advertisement display histories during a time period during which the user is not using the terminal. The display history transmission unit 218 acquires the stored advertisement display history from the advertisement display history storage unit 217 (step S701).

Further, the display history transmission unit 218 transmits the acquired advertisement display history to the advertisement distribution server 101 (step S702).

If the transmission is successful (Yes at step S703), the display history transmission unit 218 deletes the transmitted advertisement display history from the advertisement display history storage unit 217 (step S704). If the transmission fails (No at step S703), the display history transmission unit 218 attempts retransmission (step S702).

The display history receiving unit 117 receives the advertisement display history transmitted from the display history transmission unit 218 (step S705). The display history receiving unit 117 outputs the received advertisement display history to the display history information storage unit 118.

The display history information storage unit 118 stores the input advertisement display history (step S706). The information stored in the display history information storage unit 118 is a content in which the advertisement ID 1, the area ID 1050, and the display time and date are associated with each other as illustrated in FIG. 10.

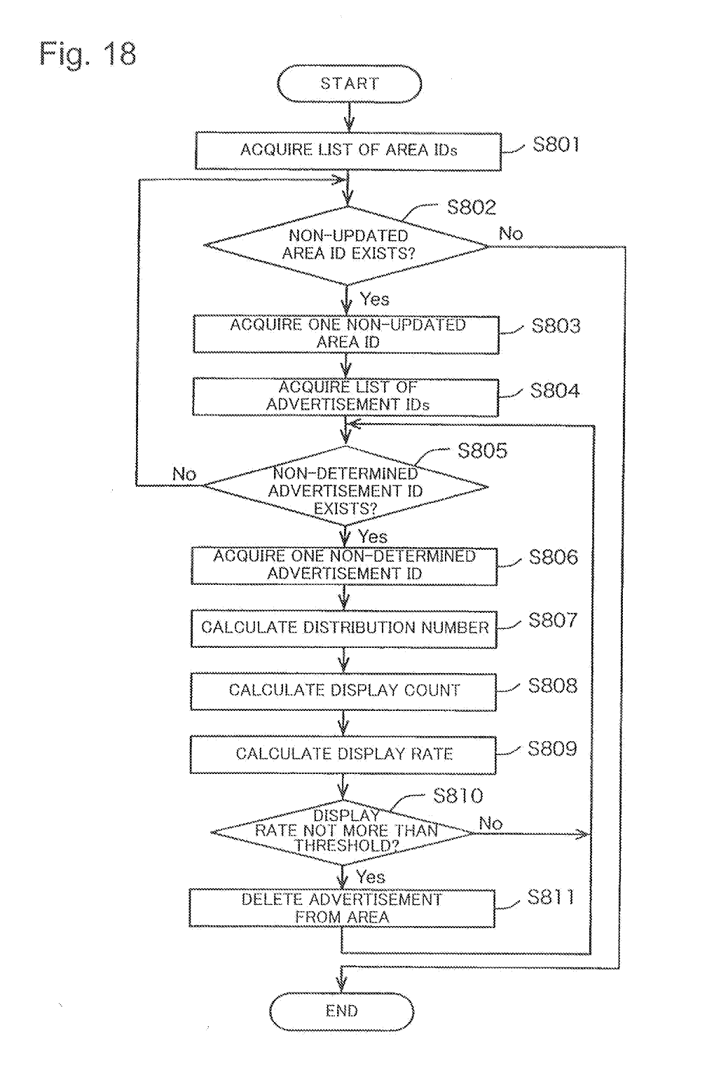

Next, the following will describe operation of the distribution area update unit 119 when updating the information of a distribution area with reference to FIG. 18. FIG. 18 is a flowchart illustrating operation of update processing of distribution area information in the distribution area update unit 119.

The distribution area update unit 119 refers to the distribution history information storage unit 116 and acquires a list of area IDs that have distribution histories (step S801). Here, the distribution area update unit 119 acquires the list of area IDs only from those with history information that has been updated since execution of the previous distribution area update processing among the distribution history information.

The distribution area update unit 119 confirms whether or not there is any non-updated area ID in the list of the acquired area IDs (step S802). If there is no non-updated area ID (No at step S802), the distribution area update unit 119 ends the processing.

If there are non-updated area IDs (Yes at step S802), the distribution area update unit 119 retrieves one non-updated area ID from the list of the acquired area IDs (step S803).

The distribution area update unit 119 refers to the distribution history information storage unit 116 again and acquires a list of advertisement IDs with distribution histories for the retrieved one area ID (step S804). In the same way as the list of area IDs, for the advertisement IDs, the list of advertisement IDs are acquired only from those with history information that has been updated since the execution of the previous distribution area update processing.

The distribution area update unit 119 confirms whether or not there is any non-determined advertisement ID in the list of the acquired advertisement IDs (step S805). If there is no non-determined advertisement ID (No at step S805), the distribution area update unit 119 returns to step S802 and executes the processing for the next non-updated area ID.

If there are non-determined advertisement IDs (Yes at step S805), the distribution area update unit 119 retrieves one non-determined advertisement ID from the list of the acquired advertisement IDs (step S806).

The distribution area update unit 119 refers to the distribution history information storage unit 116 and calculates the number of advertisement distribution from the distribution history corresponding to the retrieved one area ID and one advertisement ID (step S807). The history information as the calculation target is only the history information that has been updated since the execution of the previous distribution area update processing.

As with the number of advertisement distribution, the distribution area update unit 119 refers to the display history information storage unit 118 and calculates the count of advertisement display from the display history corresponding to the retrieved one area ID and one advertisement ID (step S808). The history information as the calculation target is only the history information that has been updated since the execution of the previous distribution area update processing.

The distribution area update unit 119 calculates a display rate by dividing the display count calculated at step S808 by the number of distribution calculated at step S807 (step S809).

After calculating the display rate, the distribution area update unit 119 determines whether the calculated display rate is not more than a threshold value (step S810). The threshold value is, for example, 10% or the like.

If the calculated display rate is more than the threshold value (No at step S810), the distribution area update unit 119 returns to step S805 without performing any particular processing to continue the processing for the next non-determined advertisement ID.

If the calculated display rate is not more than the threshold value (Yes at step S810), the distribution area update unit 119 deletes the distribution area information corresponding to the retrieved one area ID and one advertisement ID that are stored in the distribution area information storage unit 112 (step S811).

After deletion of the distribution area information, the distribution area update unit 119 returns to step S805 and executes the processing for the next non-determined advertisement ID. The distribution area update unit 119 performs the update processing until there is no more non-updated area ID and non-determined advertisement ID, then, ends the processing when there is no non-updated area ID.

If the display rate calculated at step S809 is low, which means that users who are passing through the area of the target area ID seldom move into the area which is set to display the advertisement of the target advertisement ID. Thus, distributing the advertisement of the target advertisement ID to users who are passing through the area of the target area ID is more likely to be meaningless.

By repeating the above update processing, the advertisement distribution area is reduced to the range within which the prior distribution is effective. On the other hand, as the distribution area never becomes smaller than the display area, reduction in the size of the distribution area does not negate the distribution of the advertisement.

A specific example of the update processing will be described using an example of the entrance record of a user on the map illustrated in FIG. 16. As described above, if a certain user is in the area corresponding to the area ID 1050, the advertisement information of advertisement IDs 1 and 2 is distributed to the user terminal 201. Thereafter, if the user moves along a route indicated by 1100, only advertisement 1 is displayed on the user terminal 201.

If many users take such a route, the display rate corresponding to a pair of the area ID 1050 and the advertisement ID 2 becomes not more than a threshold value. Thus, the distribution area update unit 119 determines that it is meaningless to distribute the advertisement information corresponding to the advertisement ID 2 to a user who is in the area corresponding to the area ID 1050.

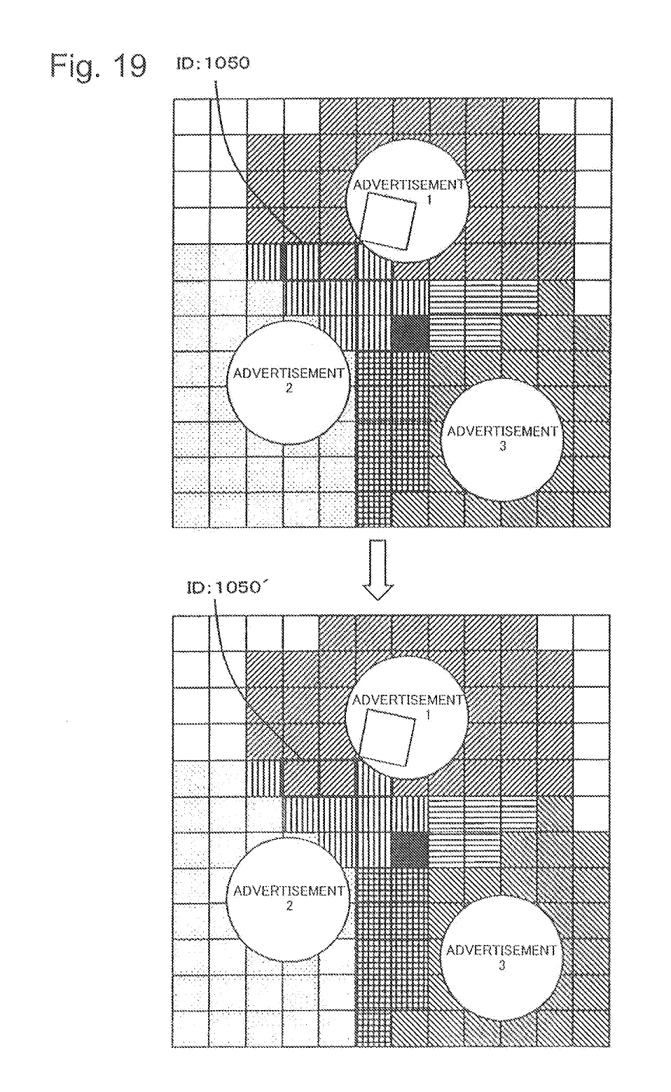

After the determination, the distribution area update unit 119 deletes the distribution area information corresponding to the area ID 1050 and the advertisement ID 2, which is stored in the distribution area information storage unit 112. Thus, as illustrated in FIG. 19, the advertisement information that is distributed to a user who is in the area corresponding to the area ID 1050 is changed from the advertisement information corresponding to the advertisement IDs 1 and 2 to only the advertisement information corresponding to the advertisement ID 1.

If the information distribution system of the exemplary embodiment is used, the timing of displaying information can be locally determined on the user terminal side, enabling real time determination in accordance with the user movement compared with determination on the server side via the network.

This is because, as the range for distributing information is set separately from the range for displaying the information, and the information is distributed in a larger range than the range for displaying, if the server side determines that the distribution condition is satisfied as necessary, the server distributes information to the user terminal before the display condition is met, allowing a user to receive the information before the user actually enters the range for displaying.

Further, the information distribution system of the exemplary embodiment also includes a function of deleting excess distribution that occurs with a widened distribution range based on the past distribution histories and display histories.

If the information distribution system of the exemplary embodiment is used, congestion of wireless communications can be avoided even in an area where the distribution information is concentrated. This is because by expanding the communication timing not only to when the user is in the area of displaying the distribution information but also to when the user is around the area, the loads of wireless communications for distributing the information are more likely to be shared among adjacent base stations.

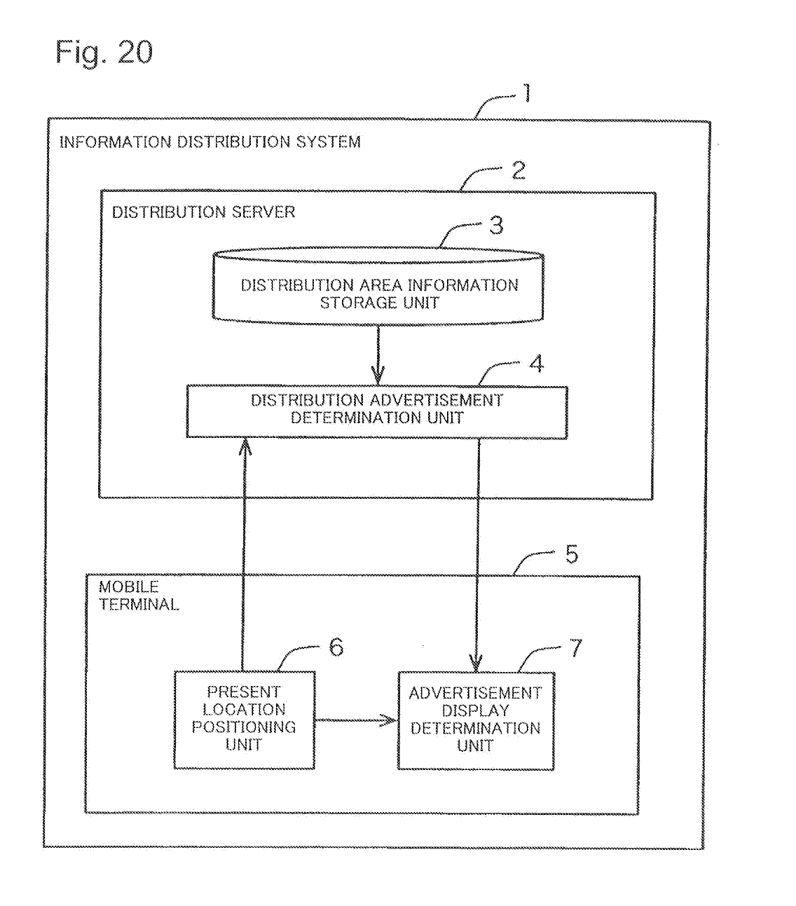

The following will describe the overview of the present invention. FIG. 20 is a block diagram illustrating the overview of the information distribution system according to the present invention. The information distribution system 1 according to the present invention includes a distribution server 2 (for example, an advertisement distribution server 101) and a mobile terminal 5 (for example, a user terminal 201) that is connected to the distribution server 2 via a communication network.

The distribution server 2 includes: a distribution area information storage unit 3 (for example, a distribution area information storage unit 112) that stores advertisement information that has a display area and a distribution region of the advertisement information that is larger than the display area of the advertisement information in association with each other; and a distribution advertisement determination unit 4 (for example, a distribution advertisement determination unit 114) that receives the present location information of the mobile terminal 5 from the mobile terminal 5 and distributes the advertisement information corresponding to the present location information, which is acquired from the distribution area information storage unit 3, to the mobile terminal 5 that has transmitted the present location information.

The mobile terminal 5 includes a present location positioning unit 6 (for example, a present location positioning unit 213) that performs positioning of the present location information of the mobile terminal 5 and transmits the present location information to the distribution server 2 and an advertisement display determination unit 7 (for example, an advertisement display determination unit 215) that determines whether to display the advertisement information distributed from the distribution server 2 based on the present location information that the present location positioning unit 6 has performed positioning after receiving the display area included in the advertisement information and the advertisement information.

With such a configuration, when a mobile terminal that is provided in this information transmission system is used, the user who is using the mobile terminal can surely receive presentation of the distributed information on the mobile terminal without delay.

Further, the distribution server 2 may include a distribution area update unit that updates information stored in the distribution area information storage unit 3.

Further, the advertisement display determination unit 7 may transmit the information that is determined to be displayed to the distribution server 2.

Further, the distribution server 2 may include the history information storage unit that stores information distributed by the distribution advertisement determination unit 4 and information transmitted by the advertisement display determination unit 7.

Further, the distribution area update unit may update information stored in the distribution area information storage unit 3 based on the information distributed by the distribution advertisement determination unit 4 and information transmitted by the advertisement display determination unit 7, which is stored in the history information storage unit.

This application claims priority based on Japanese Patent Application No. 2012-285239 filed on Dec. 27, 2012, which application is incorporated herein in its entirety by disclosure.

Although the present invention has been described so far with reference to the above-described exemplary embodiment, it is not limited thereto. A variety of modifications that will be understood by those skilled in the art can be made to the configuration and details of the invention of the present application within the scope thereof.

### INDUSTRIAL APPLICABILITY

The present invention is preferably applied to an information distribution system that provides an advertisement distribution service for car navigation systems and smartphones.

### REFERENCE SIGNS LIST

1, 100 Information distribution system
2 Distribution server
3 Distribution area information storage unit
4 Distribution advertisement determination unit
5 Mobile terminal
6 Present location positioning unit
7 Advertisement display determination unit
101 Advertisement distribution server
111 Advertisement information storage unit
112 Distribution area information storage unit
113 Present location receiving unit
114 Distribution advertisement determination unit
115 Advertisement distribution unit
116 Distribution history information storage unit
117 Display history receiving unit
118 Display history information storage unit
119 Distribution area update unit
201 User terminal
211 Distribution advertisement receiving unit
212 Received advertisement storage unit
213 Present location positioning unit
214 Present location transmission unit
215 Advertisement display determination unit
216 Advertisement display unit
217 Advertisement display history storage unit
218 Display history transmission unit
301 Network

1. An information distribution system comprising:
a distribution server; and
a mobile terminal that is connected with the distribution server via a communication network,
the distribution server comprising:
a distribution area information storage unit configured to store advertisement information that has a display area and a distribution region of the advertisement information that is larger than the display area of the advertisement information in association with each other; and
a distribution advertisement determination unit configured to receive present location information of the mobile terminal from the mobile terminal and distribute the advertisement information corresponding to the present location information, which is acquired from the distribution area information storage unit, to the mobile terminal that has transmitted the present location information, and
the mobile terminal comprising:
a present location positioning unit configured to perform positioning of the present location information of the mobile terminal and transmit the present location information to the distribution server; and
an advertisement display determination unit configured to determine whether to display the advertisement information distributed from the distribution server based on a display area included in the advertisement information and the present location information that the present location positioning unit has performed positioning after receiving the advertisement information.

2. The information distribution system according to claim 1, wherein the distribution server comprises a distribution area update unit configured to update information stored in the distribution area information storage unit.

3. The information distribution system according to claim 2, wherein the advertisement display determination unit transmits the information that has been determined to be displayed to the distribution server.

4. The information distribution system according to claim 3, wherein the distribution server comprises a history information storage unit configured to store information distributed by the distribution advertisement determination unit and information transmitted by the advertisement display determination unit.

5. The information distribution system according to claim 4, wherein the distribution area update unit updates information stored in the distribution area information storage unit based on the information distributed by the distribution advertisement determination unit and the information transmitted by the advertisement display determination unit, which is stored in the history information storage unit.

6. An information distribution method that is executed by a distribution server that is connected via a communication network with a mobile terminal that performs positioning of present location information and determines whether to display distributed advertisement information based on a display area in advertisement information and the present location information that has been performed positioning after receiving the advertisement information, the information distribution method comprising:
storing the advertisement information that has the display area and a distribution region of the advertisement information that is larger than the display area of the advertisement information in association with each other;
receiving the present location information of the mobile terminal from the mobile terminal; and
distributing the advertisement information corresponding to the present location information to the mobile terminal that has transmitted the present location information.

7. The information distribution method according to claim 6, further comprising:
updating the advertisement information that has the display area and information of a distribution region of the advertisement information that is larger than the display area of the advertisement information, which has been stored in association with each other.

8. A non-transitory computer-readable recording medium on which an information distribution program is recorded, wherein the information distribution program that is installed in a distribution server that is connected via a communication network with a mobile terminal that performs positioning of present location information and determines whether to display distributed advertisement information based on a display area in the advertisement information and the present location information that has been performed positioning after receiving the advertisement information, causes the distribution server to execute:
storing processing that stores the advertisement information that has the display area and a distribution region of the advertisement information that is larger than the display area of the advertisement information in association with each other;
receiving processing that receives the present location information of the mobile terminal from the mobile terminal; and
distributing processing that distributes the advertisement information corresponding to the present location information that has been stored by the storing processing to the mobile terminal that has transmitted the present location information that has been received by the receiving processing.

9. The non-transitory computer-readable recording medium according to claim 8, wherein the information distribution program further causes the distribution server to execute:
updating processing that updates advertisement information that has the display area and information of the distribution region of the advertisement information that is larger than the display area of the advertisement information, which has been stored in association with each other.
